(19) United States
(12) Patent Application Publication
(10) Pub. No.: US 2025/0318536 A1
(43) Pub. Date: Oct. 16, 2025

(54) Method of producing crimped edge tart bases in a machine for processing pastry portions for the production of crimped edge tart bases and such a processing machine

(71) Applicant: FLAMM TOP, SARREBOURG (FR)

(72) Inventors: Christian WINGER, WALSCHEID (FR); Olivier MULLER, PLAINE-DE-WALSCH (FR); Loic WINGER, HARTZVILLER (FR); Jacques CHOULOT, SAINT LOTHAIN (FR); Lionel JEUNET, ENTRE-DEUX-MONTS (FR)

(21) Appl. No.: 18/988,889

(22) Filed: Dec. 20, 2024

(30) Foreign Application Priority Data
Dec. 21, 2023 (FR) 2314845

(51) Int. Cl. A21C 11/00; A21C 9/08; A21D 13/30

(52) U.S. Cl. CPC A21C 11/006; A21C 9/088; A21D 13/30

(57) ABSTRACT

A method is provided for producing crimped edge tart bases in a pastry portion processing machine for the production of crimped edge tart bases. The processing machine has a control device and at least one processing module. The processing module has at least one press, at least one crimping station including a horizontal turntable and at least one crimper mobile in a crimping zone fixed relative to the turntable and first, second and third transfer means. The method includes carrying out steps under the control of the control device after the transfer of each pastry portion into the press by means of the first transfer means. The press forms a tart base with a circular edge by pressing the pastry portion in the press. The tart base is transferred from the press onto the turntable by means of the second transfer means, then coordinated control of the crimper and the rotation of the turntable to obtain a succession of overlapping crimps by successively crimping the section of the edge of the tart base located in the crimping zone and projecting from the turntable over all of the circumference of the edge of the tart base. The crimped edge tart base is evacuating by means of the third transfer means.

### RELATED APPLICATION

This application claims the benefit of priority from French Patent Application No. 23 14845, filed on Dec. 21, 2023, the entirety of which is incorporated by reference.

### FIELD OF THE INVENTION

The present invention concerns the field of food and more particularly the field of machines for processing pastry portions before cooking. It has for object a method of producing crimped edge tart bases in a machine for processing pastry portions for the production of crimped edge tart bases and such a processing machine.

### DESCRIPTION OF RELATED ART

Known already are crimped edge tart bases produced industrially by the present applicant. Such tart bases are then filled to form crimped edge tarts and then generally deep frozen to be sold.

Apart from its original aesthetic effects, the crimped edge enables equalisation of a tart base edge that is not perfectly circular (or round) and creation of mechanical strength in the tart base avoiding precooking.

These crimped edge tart bases are at present produced manually by operatives on production lines. They are made from pastry portions, that is to say shaped pieces of pastry, in particular in the form of pastry balls, that the operative places manually in a press. The press is controlled by the operative who then transfers the tart base obtained by hot pressing in the press onto a horizontal turntable. The operative then crimps the edge of the tart base by hand all around its circumference by making a succession of overlapping crimps conferring on the edge crimped in this way a braided appearance.

These manual operations require a lengthy apprenticeship to obtain a satisfactory productivity and are demanding for the operative because they require muscular efforts that can be accompanied by joint pains impacting their health and exposing them to painfulness factors that can leave long-lasting traces.

### Objects and Summary

The present invention has for object alleviating these drawbacks while enabling improved productivity by proposing a method of producing crimped edge tart bases in a machine for processing pastry portions for the production of crimped edge tart bases and such a processing machine.

The method in accordance with the present invention of producing crimped edge tart bases in a pastry portion processing machine for the production of crimped edge tart bases, the processing machine comprising a control device and at least one processing module, the processing module comprising at least one press, at least one crimping station including a horizontal turntable and at least one crimper mobile in a crimping zone fixed relative to the turntable and first, second and third transfer means, is characterised in that it consists in carrying out the following steps under the control of the control device after the transfer of each pastry portion into the press by means of the first transfer means:
the press forming a tart base with a circular edge by pressing the pastry portion in the press,
transferring the tart base from the press onto the turntable by means of the second transfer means, then coordinated control of the crimper and the rotation of the turntable to obtain a succession of overlapping crimps by successively crimping the section of the edge of the tart base located in the crimping zone and projecting from the turntable over all of the circumference of the edge of the tart base,
evacuating by means of the third transfer means the crimped edge tart base obtained in this way.

The pastry portion processing machine in accordance with the present invention for producing crimped edge tart bases is characterised in that it comprises a control device and at least one processing module, the processing module comprising:
at least one press enabling production of circular edge tart bases by pressing, preferably hot pressing, each pastry portion transferred into the press,
at least one crimping station including a horizontal turntable of circular shape and at least one crimper mobile in a crimping zone fixed relative to the turntable, the control device being able and intended for coordinated control of the crimper and the turntable after the transfer of a tart base onto the turntable to obtain a succession of overlapping crimps by successively crimping the section of the edge of the tart base located in the crimping zone and projecting from the turntable over all or part of the circumference of the edge of the tart base,
first transfer means for feeding the press with pastry portions, second transfer means for feeding the crimping station with tart bases, able and intended to transfer each tart base formed by the press onto the turntable and centred on the latter, and third transfer means for evacuating each crimped edge tart base obtained in this way, the control device being able and intended to control said first, second and third transfer means.

### BRIEF DESCRIPTION OF THE DRAWINGS

The invention will be better understood thanks to the following description, which relates to a preferred embodiment provided by way of non-limiting example and explained with reference to the appended diagrammatic drawings, in which:

FIG. 1 is a diagrammatic perspective view of a processing module of a processing machine according to the present invention in a preferred embodiment of the processing module with two crimping stations situated on respective opposite sides of the press.

FIG. 2 is a diagrammatic perspective view of one of the two crimping stations represented in FIG. 1.

FIG. 3 shows the crimping station from FIG. 2 with a tart base transferred into the crimping station and resting on the turntable with the retaining finger in its retaining position.

FIG. 4 shows the crimping position from FIG. 3 with the marker in its marking position.

FIG. 5 is a partial view of the crimping station from FIG. 4 in another orientation and without the tart base.

FIG. 6 is a perspective view of the crimping station from FIG. 1 with the crimper in its final crimping position.

FIG. 7 is a perspective view of sucker type holding means of the third transfer means.

FIG. 8 is a diagrammatic representation of the tart base as seen from above in the following three situations:

FIG. 8a the edge of the tart base is not crimped,

FIG. 8b the edge of the tart base is crimped over a part of its circumference,

FIG. 8c the edge of the tart base is crimped over all of its circumference.

FIG. 9 is a diagrammatic perspective view of a processing machine according to the present invention including a plurality of processing modules.

### DETAILED DESCRIPTION

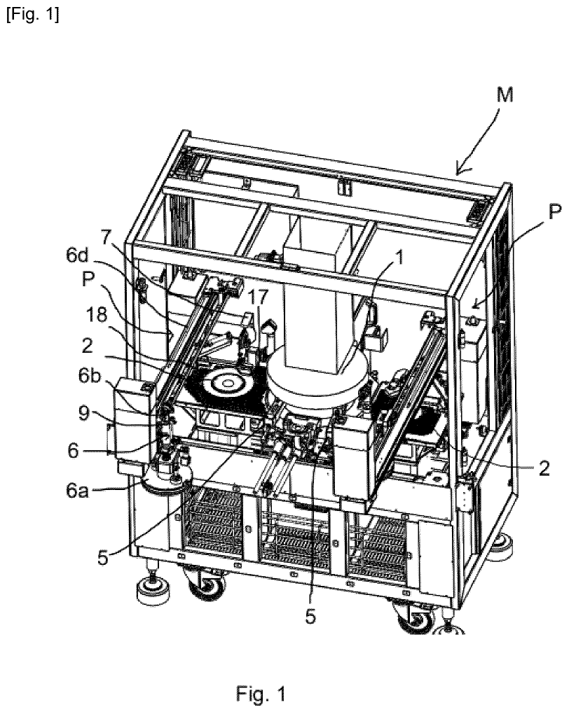

FIGS. 1 to 7 and 9 show a machine according to the present invention for processing pastry portions for the production of crimped edge tart bases F.

Such a machine may be installed in a production line, not represented, including at least one station for producing pastry portions and at least one station for filling the crimped edge tart bases. In such a production line the processing machine is then positioned between the station for producing the pastry portions and the filling station.

According to the present invention the processing machine comprises a control device and at least one processing module, the (or each) processing module comprising:
at least one press 1 enabling production of circular edge tart bases F by pressing, preferably by hot pressing, each pastry portion transferred into the press 1,
at least one crimping station P including a circular horizontal turntable 2 and at least one crimper 3 mobile in a crimping zone that is fixed relative to the turntable 1, which is to say relative to the rotation movement of the turntable 2. It is clear that the turntable 2 is moving (in rotation) relative to the crimping zone that is defined by the movement zone of the crimper 3, in particular between a waiting position and a final crimping position to be described hereinafter.

Still in accordance with the present invention, the control device is able and intended, after the transfer of a tart base F onto the turntable 2, to effect coordinated control of the crimper 3 and the rotation of the turntable 1 to obtain a succession of overlapping crimps F1 by successive crimping of the section of the edge of the tart base F located in the crimping zone and projecting from the turntable 2 over all or part of the circumference of the edge of the tart base. By overlapping is meant a section of the edge of the tart base coming to be superimposed in part on a preceding crimp. Such a succession of overlapping crimps produced in the edge of the tart base F confers on said edge crimped in this way an appearance of braiding or twisting. It is clear that the turntable 2 has a diameter less than that of the tart bases F.

It is also clear that the edge of the tart base F is the peripheral edge (or the contour or the perimeter) of the tart base F. By section of the tart base F is meant a section corresponding to a section of the edge of the tart base F substantially between two radii of the circular tart base F and the angle between the two radii is less than 45 degrees, preferably an angle between 15 and 25 degrees inclusive.

Each crimp F1 can therefore be produced with the aid of the crimper 3 by folding substantially toward the centre of the tart base F the section of the edge of the tart base F located in the crimping zone and projecting from the turntable 1, that is to say its peripheral edge.

Still in accordance with the present invention, to be able to feed the press 1 with pastry portions and the crimping station P with tart bases F the processing module further comprises:
first transfer means 4 for feeding the press 1 with pastry portions,
second transfer means 5 for feeding the crimping station with tart bases F able and intended to transfer each tart base F formed by the press 1 onto the turntable 1 and centred on the latter,
third transfer means 6 enabling evacuation of each crimped edge tart base F obtained in this way (in the crimping station).

The control device is further able and intended to control the first, second and third transfer means 4, 5, 6.

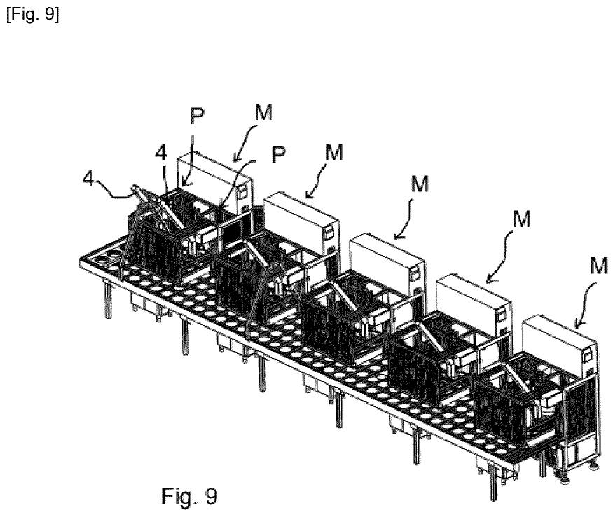

It is clear, as can be seen in FIG. 9, that the processing machine according to the present invention may comprise one or more processing modules M, for example five processing modules M as can be seen in FIG. 9. In the case of a plurality of processing modules M the processing modules M may preferably be aligned (FIG. 9).

The control device may comprise at least one control unit (or in other words, for example: a driver unit, automatic controller, management unit or control unit) for each processing module M. In the case of a single processing module the control device can then comprise only one control unit. In the case of a plurality of processing modules each processing module may comprise its own control unit. Such a control unit may contain a program executed by a processor (or microcontroller or computer) of the control unit to carry out in the processing module M the operating steps, in particular the rhythm and cadence of the operations, and in particular coordinated control of the crimper 3 and of the rotation of the turntable 1 and control of the first, second and third transfer means. In the situation where the processing machine comprises a plurality of processing modules (FIG. 9) the control device may comprise a central management unit connected to the control units specific to each processing module M.

In a preferred embodiment of such a processing module M the turntable 2 is able and intended to be rotated stepwise so as to be able to modify the angular position of the turntable 2 on each step controlled by a control signal. Furthermore, the control unit may then be able and intended for coordinated control of the crimper 3a and the stepwise rotation of the turntable 2 in a predetermined number of steps so as to produce each crimp F1 in a predetermined angular position of the turntable 2 and during the next step to modify the angular position of the tart base F resting on the turntable 1 to produce the next crimp F1.

The turntable 2 can therefore be rotated stepwise so as to be moved in each step by a predetermined rotation. It is clear that the rotation of the turntable 2 enables driving in rotation of the tart base F that is resting on the turntable 2 and constrained to rotate with the latter. For example, to produce 18 crimps F1 the turntable 2 can be turned 20° (or approximately) 20° in each step.

It is clear that in each step a different section of the edge of the tart base F is located in the crimping zone.

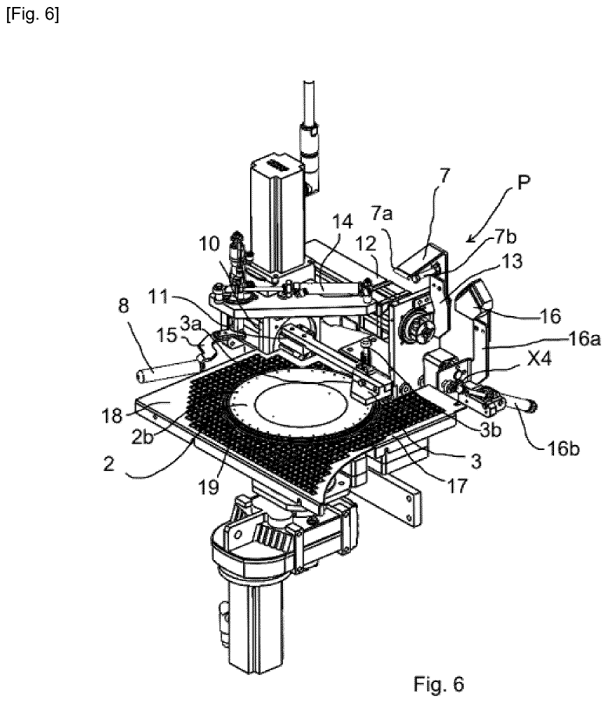

The crimper 3 is preferably mounted to pivot about a horizontal axis. The crimper 3 may preferably include a plate, preferably of globally rectangular shape. As can be seen in FIG. 6 the crimper 3 may preferably include a bevelled corner 3a enabling crimping of a section of the edge of the tart base F imparting greater volume to the crimp so as not to obtain a flat or flattened crimp (see FIG. 6 in particular).

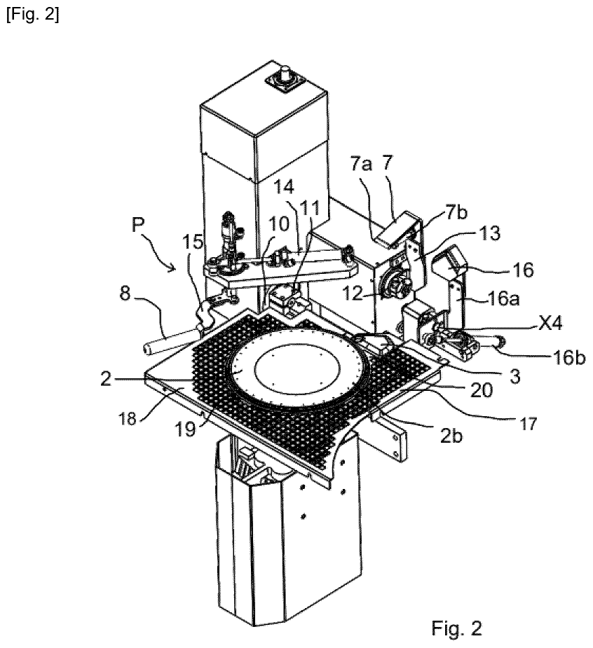

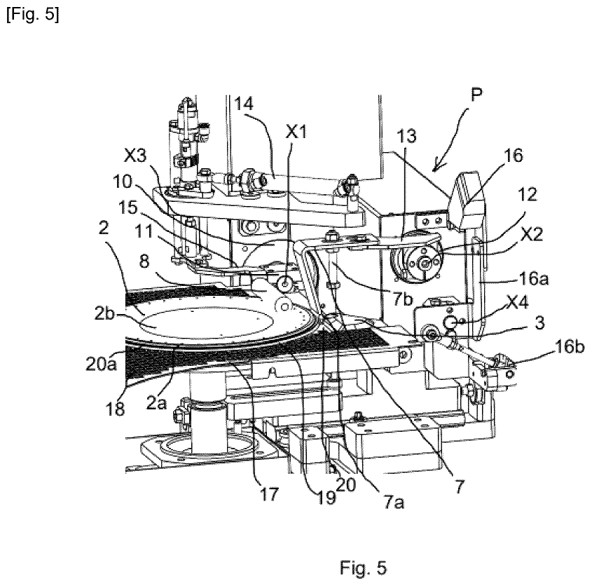

The mobile crimper 3 is preferably intended to be moved, preferably by pivoting about a horizontal axis, between a waiting position situated beside the turntable 2 and substantially aligned with the edge of the turntable 2 (FIGS. 2 and 5) to a final crimping position situated above the turntable 2 (FIG. 6). The movement between the waiting position and the final crimping position makes it possible to crimp the corresponding section of the edge of the tart base F to form a crimp F1. Such a waiting position enables the crimper 3 to extend below the section of the edge of the tart base F located in the crimping zone and projecting from the turntable 2 in order to be able to grasp said section and to crimp it as it moves to the final crimping position, in particular by folding it toward the centre of the turntable 2.

The crimper 3 may preferably be mobile in a vertical plane, called the crimping plane, off-axis relative to the centre of the turntable 2. By “off-axis” is meant that the crimping plane does not pass through the centre of the turntable 2. This off-axis arrangement enables the crimper 3 to crimp a greater quantity of pastry and to produce a wider crimp F1.

To actuate the crimper 3 under the control of the control device the processing module M may comprise an actuator 10 which may for example consist of a cylinder or an electric motor controlled by the control device. The crimper 3 may be mounted on a support 11 driven in rotation about a horizontal axis X1 so as to be able to move the crimper 3 so that it pivots between its waiting position and its final crimping position. The axis X1 therefore forms a pivot axis of the crimper 3.

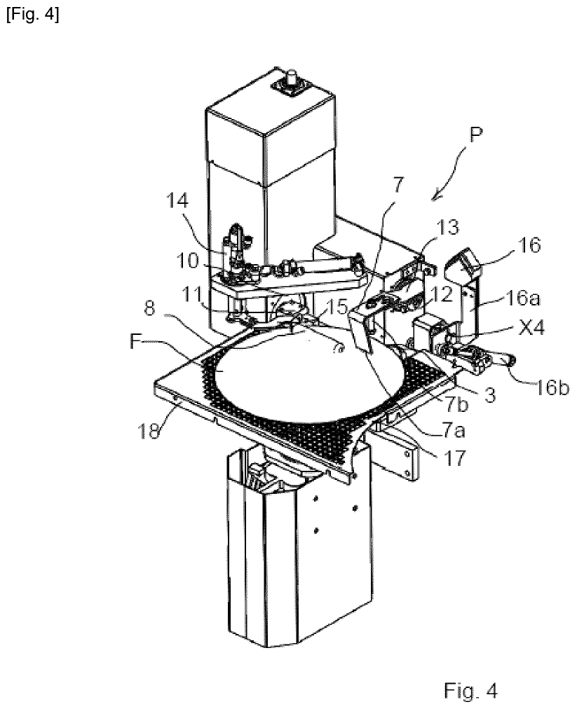

In a preferred embodiment, as can be seen in FIGS. 2 to 7 in particular, the crimping station P may further comprise a mobile marker 7, preferably made of metal, associated with the crimper 3. By “associated” is meant that the marker 7 and the crimper 3 form a marking/crimping assembly enabling optimised production of a crimp F1. The marker 7 may include a preferably rectilinear horizontal bearing edge 7a and may be mobile between a waiting position (FIGS. 1 to 3, 6) and a marking position in the crimping zone (FIGS. 4 and 5). The bearing edge 7a is preferably rounded. In the marking position the marker 7 may be able and intended to exert, via its bearing edge 7a, pressure in the tart base F set back from the section of the edge of the tart base F located in the crimping zone so as to create a mark in the pastry (the material of the tart base F) forming in the latter a point of inflection. The point of inflection must be understood as forming a zone of weakness in the pastry, this zone optionally taking the form of a line. The control device can then be able and intended to produce each crimp F1:
by moving the marker 7 from the waiting position to the marking position, then returning the marker 7 to its waiting position,
then causing the crimper 3 to crimp the corresponding section of the edge of the tart base F about the point of inflection.

The turntable 2 may preferably comprise on its upper face an annular rim 2a set back from its peripheral edge (or its contour) so as to create an annular groove 20a (or shoulder) facing toward the exterior of the turntable 2, and the bearing edge 7a of the marker 7 is able and intended to come into its marking position in the annular groove 20a. The position of the bearing edge 7a in the annular groove makes it possible to exert pressure on the pastry to form the aforementioned point of inflection (FIGS. 4, 5).

To actuate the marker 7 under the control of the control device the processing module M may comprise an actuator 12 controlled by the control device and which may for example consist of a cylinder or an electric motor. The marker 7 may be mounted on a support 13 driven in rotation by the actuator 12 about a horizontal axis X2. The axis X2 thus forms a pivot axis of the marker 7.

The marker 7 may preferably have an L-shape one of the edges of which forms the bearing edge 7a.

Thanks to such a crimping assembly a preferred form of the present invention enabling finalisation of the crimping of the last crimp F1 may be such that the crimper 3 is able and intended, in the final crimping position, to be located on the trajectory of the marker 7 and so that the crimper 3 includes a bearing element 3a. The marker 7 may then be able and intended, as it moves towards the marking position and when the crimper 3 is in the final crimping position, to come into contact with pressure on the bearing element 3a of the crimper 3a. The marker 7 may preferably comprise a contact element 7b able and intended to come into contact with the bearing element 3a of the crimper 3 (see in particular FIGS. 2 to 6). The contact with pressure (or the pressure) on the crimper 3 enables finalisation of the last crimp F1, in particular closing of the edge crimped in this way.

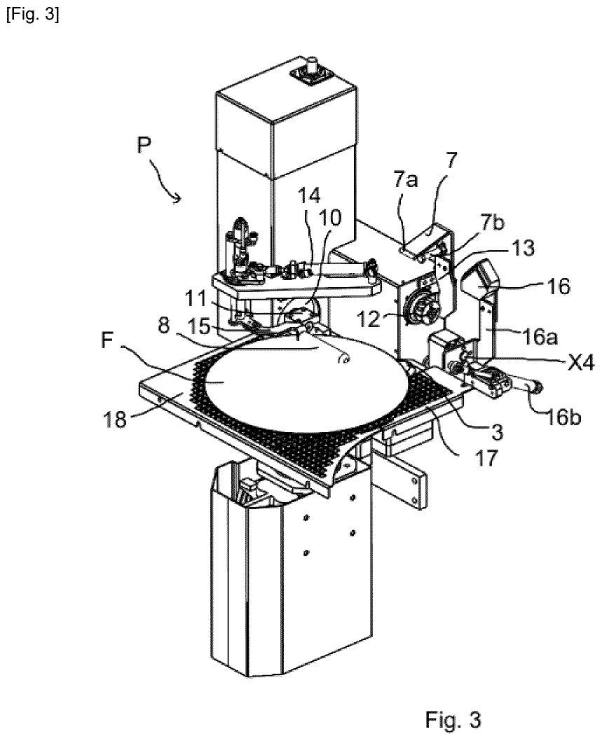

As can be seen in FIGS. 2 to 6 in particular, the crimping station P may preferably comprise a retaining finger 8 mobile between a waiting position (FIGS. 2, 6) and a retaining position above the turntable 2 (FIGS. 3 to 5) so as to make it possible, at the start of crimping during the production of a predetermined number of crimps F1, to retain the tart base F under the retaining finger 8. This makes it possible to make the pastry sufficiently strong for the remainder of the crimping.

To actuate the retaining finger 8 under the control of the control device the processing module M may comprise an actuator 14, for example a cylinder or an electric motor, controlled by the control device. The retaining finger 8 may then be mounted on a support 15 driven in rotation by means of the actuator 14 about a vertical axis X3. The axis X3 thus forms a pivot axis of the retaining finger 8.

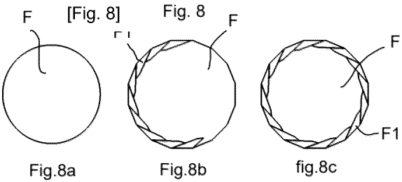

The crimping station P may further comprise a retaining shoe 16 mobile between a waiting position and a retaining position above the turntable 2. The retaining shoe 16 in the retaining position enables retention of the tart base F by preventing too great a section of the edge of the tart base F from being raised by the crimper 3 starting from a certain length of the crimped edge, notably from approximately two-thirds of the circumference of the tart base F (FIG. 8b), because from this length (circumference) the pastry is not heavy enough, with the result that too great a section (compared to the preceding sections) would be crimped by the crimper 3. The shoe 16 may be fixed onto a support 16a driven in rotation about a horizontal axis X4 by means of an actuator 16b, for example of the cylinder type, controlled by the control device. The axis X4 therefore forms a pivot axis of the shoe 16.

The respective pivot axes X1, X2 and/or X4 of the crimper 3, the marker 7 and/or the shoe 16 are preferably parallel to one another.

Referring in particular to FIGS. 1 to 6, it can be seen that the second transfer means 5 can be considered to be able to transfer each tart base F from the press 1 to the turntable 2 by grasping it and sliding it on a continuous or quasi-continuous horizontal transfer surface 17 extending at the same level as the turntable 2 (in particular its upper face) and at least between the press 1 (the surface supporting the tart base F) and the turntable 2. These second transfer means 5 may comprise a carriage mobile in translation between the press 1 and the turntable 2 that can be fitted with suckers or other holding means enabling grasping of the tart base F to slide it onto the horizontal transfer surface 17.

It can also be seen in FIGS. 1 to 6 that the crimping station 7 may comprise a retaining and/or sliding horizontal plate 18, preferably made of metal, for example sheet metal, in which is formed a through-opening 19 receiving the turntable 2 and a cut-out 20 opening into the through-opening 19 to create a passage enabling the section of the edge of the tart base F located in the crimping zone to rest on the crimper 3 in the waiting position and during passage of the crimper 3 to the final crimping position. The horizontal plate 18 makes it possible to create a horizontal surface around the turntable, except for the opening created by the cut-out 20, to retain the edge of the tart base F. The horizontal plate 18 may preferably be extended as far as the press 1 so that its upper surface forms the horizontal surface 17 for transfer by sliding.

As can be seen in FIGS. 2 and 5 the crimper 3 is preferably configured to be able to extend in a horizontal position in the waiting position.

Referring to FIGS. 1, 2, 5 and 6 it can be seen that the present invention may preferably be such that the turntable 2 can include suction holes 2b for retaining the tart base F on the turntable 2, in particular during its rotation. The suction or the vacuum (or the reduced pressure) created by each suction hole 2b can be produced by means of a vacuum pump, for example a piston vacuum pump, or a centrifugal pump, or by means of a vacuum generator such as ejectors employing the venturi principle that are particularly suitable for automating such a processing machine.

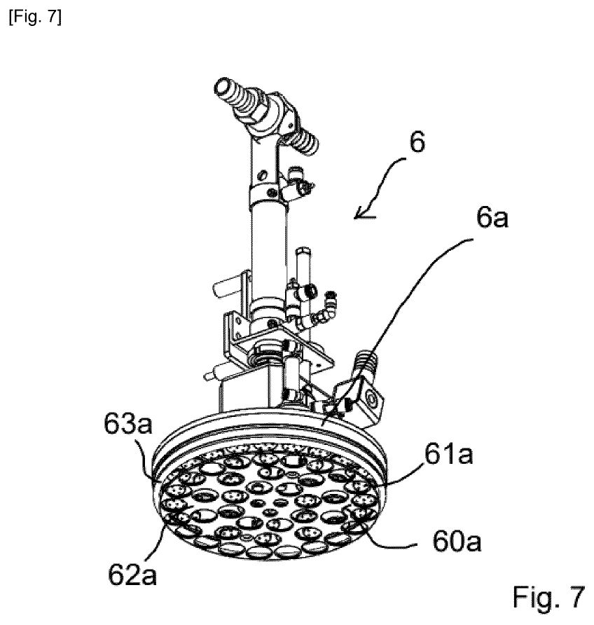

Referring to FIG. 1 and FIG. 7, it can be seen that the third transfer means 6 may preferably comprise a suction grasper 6a. The suction grasper 6a may include a suction face 60a, preferably of circular shape, and preferably plane, provided with suction and/or blowing holes 61a for grasping the tart base F, preferably set back from the crimped edge. The diameter of the suction face 6a is preferably determined so as to grasp the tart base F by suction at places set back from the crimped edge so as not to deform or damage the latter. The suction face 6a therefore has a shape and dimensions enabling it to be positioned in the interior part of the crimped edge tart base F. In operation the suction grasper is lowered, for example by means of an articulated arm 9, toward the crimped edge tart base F resting on the turntable 2 to grasp the tart base F by a suction/vacuum effect, after which it is moved with the tart base F outside the module M for its evacuation. Evacuation may consist in transferring the tart base F to an evacuation conveyor (not represented), releasing it onto the latter by interrupting the vacuum. A blowing effect via the suction/blowing holes 60a enables assistance with the ejection of the tart base F, which can remain stuck to the sucker. Furthermore, to optimise release/ejection and to preserve the shape and the crimped edge of the tart base F that may be affected by the ejection, the suction grasper further includes a mobile ejection grille 62 extending in front of the suction/blowing face 60a or in operation during the grasping of a tart base F between the tart base F and the suction/blowing face 60a. The ejection grille 62a may preferably be mobile in translation perpendicularly to the suction/blowing face 60a. The ejection grill 62a may preferably be made of a material such as PTFE preventing the pastry (of the tart base F) from sticking to the ejection grille 62a. Moving the ejection grille 62a therefore enables pushing of the tart base F and prevention of any sticking of the pastry against the suction/blowing face 60a. Finally the present invention may advantageously be such that a flexible annular seal 63a surrounds the edge of the suction/blowing face 60a. In the grasping position of the suction grasper the annular seal 63a extends against the internal face of the crimped edge of the tart base F, which enables the crimped edge to be retained during grasping of the tart base F, because the latter may fall and/or be deformed by gravity during the movement of the suction grasper. The suction or the vacuum (or the reduced pressure) created by each suction hole 61 may be produced by means of a vacuum pump, for example a piston vacuum pump, or a centrifugal pump or by means of a vacuum generator such as ejectors functioning on the venturi principle that are particularly suitable for automating such a processing machine.

The third transfer means 6 may further comprise a carriage 6b mobile, preferably in translation, above the turntable 2 and between the crimping station P and a point for evacuation and ejection of the tart base F so grasped, for example located above an evacuation conveyor located beside the processing module M, to transport the crimped edge tart base F to a filling station of a processing line. A guide rail 6c enables the movement in translation of the carriage 6b mounted on the latter.

The processing machine may preferably comprise at least one human-machine interface including a display screen enabling control and/or programming of the various parameters (number of crimps, crimping speed, turntable step, etc.). To be more specific the or at least one of the processing modules M may have its own human-machine interface to enable control and/or programming of the various parameters (number of crimps, crimping speed, turntable step, etc.) specific to the function of the processing module M.

The present invention also has for object a method of producing crimped edge tart bases F in a pastry portion processing machine for the production of crimped edge tart bases F. The processing machine may be a processing machine according to the present invention which then enables use of the method.

According to the present invention the method consists in carrying out the following steps under the control of the control unit after the transfer of each pastry portion into the press 1 by means of the first transfer means 4:
the press 1 forming a tart base F with a circular edge by pressing the pastry portion in the press 1,
transferring the tart base F from the press 1 to the turntable 1 by means of the second transfer means 5 followed by coordinated control of the crimper 3 and the rotation of the turntable 1 to obtain a succession of overlapping crimps F1 by successive crimping (by means of the crimper 3) of the section of the edge of the tart base F located in the crimping zone and projecting from the turntable 2 over all or part of the circumference of the edge of the tart base,
evacuating by means of the third transfer means 6 the tart base F with braided edge obtained in this way.

Such a succession of overlapping crimps in the edge of the tart base F confers on said edge a braided or twisted appearance.

When the turntable 2 is able and intended to be rotated stepwise and to be stopped on each step so as to be able to modify in each step under the control of a control signal the angular orientation of the turntable 2, the method may consist in coordinated control of the crimper 3a and the stepwise rotation of the turntable 2 in a predetermined number of steps so as to produce each crimp F1 in a predetermined angular position of the turntable 2 and to modify in the next step the angular position of the tart base F resting on the turntable 1 to produce the next crimp F1.

Each crimp F1 is preferably produced by means of the crimper 3 by folding substantially toward the centre of the tart base F the section of the edge of the tart base F located in the crimping zone and projecting from the turntable 1.

The method preferably consists in controlling the crimper 3 so as to move it, preferably by pivoting about a horizontal axis, between a waiting position beside the turntable 2 so that the crimper 3 extends under the section of the edge of the tart base F located in the crimping zone and projecting from the turntable 2 to a final crimping position above the turntable 2. The movement between the waiting position and the final crimping position enables crimping of the corresponding section of the edge of the tart base F to form a crimp F1.

The crimper 3 is preferably mobile by pivoting about a horizontal axis.

When the crimping station P comprises a mobile marker 7 associated with the crimper 3 the method may consist in carrying out the following sequence to produce each crimp:
the marker 7 moving in the crimping zone into a marking position above the turntable 2 as to exert in the marking position via its bearing edge 7a pressure on the tart base F (slightly) set back from the section of the edge of the tart base F located in the crimping zone to create a mark in the pastry forming a point of inflection, the marker 7 then returning to its waiting position,
the crimper 3 crimping said section of the edge of the tart base F about the point of inflection.

During production of the last crimp F1 the method may consist in the marker 7 again moving toward the crimper 3 in the crimping position so that the marker 7 comes into contact with pressure on the crimper 3 to finalise the last crimp F1, in particular to close the edge crimped in this way.

The method preferably consists in hot pressing the pastry to form the tart base.

The method may preferably consist in moving the crimper 3 in a vertical plane, called the crimping plane, off-axis relative to the centre of the turntable 2. By “off-axis” is meant that the crimping plane does not pass through the centre of the turntable or, in other words, is parallel to a radius of the turntable 2.

If the crimping station P comprises a retaining finger 8 mobile between a waiting position and a retaining position above the turntable 2 the method may preferably consist, at the start of crimping during production of a predetermined number of crimps F1, in the retaining finger 8 in the retaining position retaining the tart base F under the retaining finger 8. As mentioned above, this makes it possible to obtain sufficient strength of the pastry for the remainder of the crimping.

If the processing module M comprises two crimping stations P disposed on respective opposite sides of the press 1 the method may preferably consist in alternately feeding tart bases F to the two crimping stations P by means of the second transfer means 4.

The method may preferably consist in transferring each tart base F from the press 1 to the turntable 2 by sliding the tart base F by means of the second transfer means 5 onto a continuous or quasi-continuous horizontal surface 17 extending at the same level as the turntable 2 and at least between the press 1 and the turntable 2. A particular example shape of the second crimper means 5 and the horizontal surface 17 enabling this transfer by sliding are described above.

The present invention also has for object a processing line, not depicted in the appended figures, comprising:
at least one pastry portion production station,
at least one station for filling the tart bases F,
and a processing machine for producing tart bases from the pastry portions, situated downstream of the pastry portion production station and upstream of the filling station.

In accordance with the present invention, in such a processing line the processing machine consists in a processing machine according to the present invention for producing pastry portions for the production of crimped edge tart bases F.

Of course, the invention is not limited to the embodiments described and represented in the appended drawings. Modifications are possible, in particular from the point of view of the constitution the various elements or substitution of technical equivalents, without this departing from the scope of protection of the invention.

1. A method of producing crimped edge tart bases in a pastry portion processing machine for the production of crimped edge tart bases, comprising a control device and at least one processing module, the processing module comprising at least one press, at least one crimping station including a horizontal turntable and at least one crimper mobile in a crimping zone fixed relative to the turntable and first, second and third transfer means,
wherein said method includes carrying out the following steps under the control of the control device after the transfer of each pastry portion into the press by means of the first transfer means:
the press forming a tart base with a circular edge by pressing the pastry portion in the press,
transferring the tart base from the press onto the turntable by means of the second transfer means, then coordinated control of the crimper and the rotation of the turntable to obtain a succession of overlapping crimps by successively crimping the section of the edge of the tart base located in the crimping zone and projecting from the turntable over all of the circumference of the edge of the tart base,
evacuating by means of the third transfer means the crimp edge tart base obtained in this way.

2. The method according to claim 1, wherein said turntable is able and intended to be rotated stepwise and to stop in each step so as to be able, in each step under the control of a control signal, to modify the angular orientation of the turntable, and wherein said method includes coordinated control of the crimper and the stepwise rotation of the turntable in a predetermined number of steps so as to produce each crimp in a predetermined angular position of the turntable and in the next step to modify the angular position of the tart base resting on the turntable to produce the next crimp.

3. The method according to claim 1, wherein each crimp is produced by means of the crimper by folding substantially toward the centre of the tart base the section of the edge of the tart base located in the crimping zone and projecting from the turntable.

4. The method according to claim 1, wherein said method includes moving the crimper, preferably by pivoting about a horizontal axis, between a waiting position beside the turntable so that the crimper extends under the section of the edge of the tart located in the crimping zone projecting from the turntable to a final crimping position above the turntable, the movement between the waiting position and the final crimping position enabling crimping of the corresponding section of the edge of the tart base to form a crimp.

5. The method according to claim 1, wherein the crimping station comprises a mobile marker associated with the crimper and wherein said method includes carrying out the following sequence for the production of each crimp:
the marker moving in the crimping zone into a marking position above the turntable so as in the marking position to exert via its bearing edge pressure on the tart base set back from the position of the edge of the tart located in the crimping zone to create a mark in the pastry forming a point of inflection, then returning the marker to its waiting position,
the crimper then crimping said section of the edge of the tart base about the point of inflection.

6. The method according to claim 5, wherein, during the production of the last crimp, said method includes the marker again moving toward the crimper in the final crimping position so that the marker comes into contact with pressure on the crimper to finalise the last crimp.

7. The method according to claim 1, wherein the crimping station comprises a retaining finger mobile between a waiting position and a retaining position above the turntable and wherein said method includes, at the start of crimping during the production of a predetermined number of crimps, the retaining finger in the retaining position retaining the tart base under the retaining finger.

8. The method according to claim 1, wherein said method includes transferring each tart base from the press onto the turntable by sliding the tart base by means of the second transfer means onto a continuous or quasi continuous horizontal surface extending at the same level as the turntable and at least between the press and the turntable.

9. The method according to claim 1, wherein said method includes hot pressing the pastry portion to form the tart base.

10. The method according to claim 1, wherein the processing module comprises two crimping stations on respective opposite sides of the press and wherein said method includes in alternately feeding tart bases to the two crimping stations by means of the second transfer means.

11. A pastry portion processing machine for producing crimped edge tart bases, said pastry portion processing machine comprises:
a control device and at least one processing module, the processing module comprising:
at least one press enabling production of circular edge tart bases by pressing, preferably hot pressing, each pastry portion transferred into the press,
at least one crimping station including a horizontal turntable of circular shape and at least one crimper mobile in a crimping zone fixed relative to the turntable, the control device being able and intended for coordinated control of the crimper and the turntable after the transfer of a tart base onto the turntable to obtain a succession of overlapping crimps by successively crimping the section of the edge of the tart base located in the crimping zone and projecting from the turntable over all or part of the circumference of the edge of the tart base,
first transfer means for feeding the press with pastry portions, second transfer means for feeding the crimping station with tart bases, able and intended to transfer each tart base formed by the press onto the turntable and centred on the latter, and third transfer means for evacuating each crimped edge tart base obtained in this way, the control device being able and intended to control said first, second and third transfer means.

12. The processing machine according to claim 11, wherein the turntable is able and intended to be rotated stepwise so as to be able, in each step under the control of a control signal, to modify the angular position of the turntable, and in that the control device is able and intended for coordinated control of the crimper and the stepwise rotation of the turntable in a predetermined number of steps so as to produce each crimp in a predetermined angular position of the turntable and in the next step to modify the angular position of the tart base resting on the turntable to produce the next crimp.

13. The processing machine according to claim 11, wherein the mobile crimper is able and intended to be moved, preferably by pivoting about a horizontal axis, between a waiting position beside the turntable substantially aligned with the edge of the turntable to a final crimping position above the turntable, the movement between the waiting position and the final crimping position enabling crimping of the corresponding section of the edge of the tart base to form a crimp.

14. The processing machine according to claim 11, wherein the crimping station comprises a mobile marker associated with the crimper, said marker including a horizontal bearing edge and being mobile between a waiting position and a marking position in the crimping zone, in which marking position the marker is able and intended to exert, via its bearing edge, pressure on the tart base set back from the section of the edge of the tart base located in the crimping zone so as to create a mark in the pastry forming in the latter a point of inflection, and in that the control device is able and intended, for the production of each crimp:
to move the marker from the waiting position to the marking position, then to return the marker to its waiting position,
to cause the crimper to crimp the corresponding section of the tart base about the point of inflection.

15. The processing machine according to claim 14, wherein the turntable comprises on its upper face an annular rim set back from its edge so as to create an annular groove facing toward the exterior of the turntable, and in that the bearing edge of the marker is able and intended to come into a marking position in the annular groove.

16. The processing machine according to claim 14,
wherein the mobile crimper is able and intended to be moved, preferably by pivoting about a horizontal axis, between a waiting position beside the turntable substantially aligned with the edge of the turntable to a final crimping position above the turntable, the movement between the waiting position and the final crimping position enabling crimping of the corresponding section of the edge of the tart base to form a crimp, and
wherein the crimper is able and intended to be located, in the final crimping position, on the trajectory of the marker, and in that it includes a bearing element, the marker then being able and intended, during its movement to the marking position and when the crimper is in the crimping position, to come into contact with pressure on the bearing element of the crimper so as to be able to finalise the last crimp.

17. The processing machine according to claim 1, wherein the crimping station comprises a retaining finger mobile between a waiting position and a retaining position over the turntable so as to enable, at the start of crimping during the production of a predetermined number of crimps, retention of the tart base under the retaining finger.

18. The processing machine according to claim 1, wherein the third transfer means comprise a suction grasper including a suction face, preferably of circular shape, with suction holes for grasping the tart base, preferably set back from the crimped edge.

19. A processing line, said line comprising:
at least one pastry portion producing station,
at least one station for filling tart bases,
a processing machine for producing tart bases from pastry portions, situated downstream of the pastry portion production station and upstream of the filling station,
wherein the processing machine includes a pastry portion processing machine for producing crimped edge tart bases according to claim 11.
